(19) United States
(12) Patent Application Publication
(10) Pub. No.: US 2023/0090715 A1
(43) Pub. Date: Mar. 23, 2023

(54) CONNECTOR

(71) Applicant: SUMITOMO WIRING SYSTEMS, LTD., Mie (JP)

(72) Inventor: Yusuke WATANABE, Mie (JP)

(21) Appl. No.: 17/908,441

(22) PCT Filed: Mar. 2, 2021
(86) PCT No.: PCT/JP2021/007860

§ 371 Date: Aug. 31, 2022

(30) Foreign Application Priority Data
Mar. 4, 2020 (JP) 2020-037049

(51) Int. Cl. H01R 13/453

(52) U.S. Cl. CPC H01R 13/4532

(57) ABSTRACT

A connector is provided with a housing having a facing surface (41) facing a mating connector when the connector is assembled with the mating connector, a terminal held in the housing and projecting in a first direction (D1) from the facing surface, and a cover (56) to be held on the housing. The housing includes a peripheral wall (36) projecting in the first direction from the facing surface and provided to surround the terminal when viewed from a second direction opposite to the first direction. The peripheral wall (36) is provided with an exposure opening (51) for exposing inside of the housing. The cover is provided to be displaced between a first position where the cover closes the exposure opening and a second position (P2) where the cover is retracted from the exposure opening.

### TECHNICAL FIELD

The present disclosure relates to a connector.

### BACKGROUND

Patent Document 1 describes a connector provided with a housing and a terminal. The housing holds the terminal. The housing includes a peripheral wall provided to surround the terminal. The peripheral wall is provided with an exposure opening for exposing the inside of the housing. The exposure opening is provided to avoid the interference of the connector with a mating connector when the connector and the mating connector are assembled. For example, the mating connector is fit into the exposure opening when the connector and the mating connector are assembled.

### PRIOR ART DOCUMENT

### Patent Document

Patent Document 1: JP 2016-522550 A

### SUMMARY OF THE INVENTION

### Problems to be Solved

In the connector described in Patent Document 1, the inside of the housing is accessible through the exposure opening. Thus, worker's fingers may touch the terminal through the exposure opening.

The present disclosure aims to provide a connector capable of reducing a possibility that worker's fingers touch a terminal.

### Means to Solve the Problem

The present disclosure is directed to a connector with a housing having a facing surface facing a mating connector when the connector is assembled with the mating connector, a terminal held in the housing, the terminal projecting in a first direction from the facing surface, and a cover to be held on the housing, wherein the housing includes a peripheral wall projecting in the first direction from the facing surface and provided to surround the terminal when viewed from a second direction opposite to the first direction, the peripheral wall is provided with an exposure opening for exposing inside of the housing, and the cover is provided to be displaced between a first position where the cover closes the exposure opening and a second position where the cover is retracted from the exposure opening.

### Effect of the Invention

According to the connector of the present disclosure, an effect of being capable of suppressing a possibility that worker's fingers touch a terminal is achieved.

### BRIEF DESCRIPTION OF THE DRAWINGS

FIG. 1 is a perspective view showing one embodiment of an electrical connection device provided with a connector.

FIG. 2 is a plan view of a first connector viewed from a first direction.

FIG. 3 is a plan view of a second connector viewed from a second direction.

FIG. 4 is a section along 4-4 in FIG. 3.

FIG. 5 is a front view of the second connector.

FIG. 6 is a section along 6-6 in FIG. 3.

FIG. 7 is a side view of the second connector.

FIG. 8 is a plan view in which a cover is displaced to a second position from a position of FIG. 3.

FIG. 9 is a front view in which the cover is displaced to the second position from a position of FIG. 5.

FIG. 10 is a side view before the first and second connectors are assembled.

FIG. 11 is a side view after the first and second connectors are assembled.

### DETAILED DESCRIPTION TO EXECUTE THE INVENTION

### Description of Embodiments of Present Disclosure

First, embodiments of the present disclosure are listed and described.

[1] The connector of the present disclosure is provided with a housing having a facing surface facing a mating connector when the connector is assembled with the mating connector, a terminal held in the housing, the terminal projecting in a first direction from the facing surface, and a cover to be held on the housing, wherein the housing includes a peripheral wall projecting in the first direction from the facing surface and provided to surround the terminal when viewed from a second direction opposite to the first direction, the peripheral wall is provided with an exposure opening for exposing inside of the housing, and the cover is provided to be displaced between a first position where the cover closes the exposure opening and a second position where the cover is retracted from the exposure opening.

According to the above configuration, the cover is located at the second position when the connector and the mating connector are assembled, thereby reducing a possibility of interference of the connector with the mating connector. On the other hand, when the connector and the mating connector are not assembled, the cover is located at the first position, thereby closing the exposure opening. A possibility that worker's fingers touch the terminal is reduced by the cover closing the exposure opening.

Here, “facing each other” in this specification indicates that surfaces or members are at positions right in front of each other and means not only a case where the surfaces or members are at positions perfectly in front of each other, but also a case where the surfaces or members are at positions partially in front of each other. Further, “facing each other” in this specification means both a case where another member different from two members is interposed between the two members and a case where nothing is present between the two members.

[2] Preferably, the connector is provided with a pressing member for contacting the housing and the cover, the pressing member presses the cover such that the cover is displaced to the first position, and the cover is provided to be displaced to the second position by being pressed by the mating connector when the connector and the mating connector are assembled.

According to the above configuration, the cover is displaced to the second position as the connector and the mating connector are assembled. The cover is displaced to the first position as the connector and the mating connector are disassembled. In this way, a possibility that the cover is inadvertently displaced to the second position is reduced. That is, since it becomes difficult to access the inside of the housing through the exposure opening, a possibility that worker's fingers touch the terminal is reduced.

[3] Preferably, the connector is provided with a shaft member to be mounted on the housing and the cover, the pressing member is mounted on the shaft member, and the cover is displaced between the first position and the second position by rotating about the shaft member.

According to the above configuration, the cover configured to be displaced between the first position and the second position can be relatively easily configured.

[4] Preferably, in the connector, the cover includes a first end part, the shaft member being mounted on the first end part, a second end part opposite to the first end part and an extending part, the extending part is provided on the second end part, and the extending part extends outwardly of the peripheral wall from the side of the first end part toward the second end part when the cover is located at the first position.

According to the above configuration, the cover is easily displaced to the second position by the mating connector contacting the extending part when the connector and the mating connector are assembled.

[5] Preferably, in the connector, the housing includes a protecting portion for protecting the terminal, the protecting portion projects in the first direction from the facing surface, and the protecting portion is provided to surround the terminal in a region surrounded by the peripheral wall when the housing is viewed from the second direction.

According to the above configuration, a possibility that worker's fingers touch the terminal is reduced by the protecting portion surrounding the terminal.

[6] Preferably, in the connector, the peripheral wall includes a first wall provided with the exposure opening, the first wall includes a projecting part projecting in the first direction from the facing surface, and the exposure opening is so provided in the first wall that a tip of the projecting part serves as an edge.

Normally, the mating connector to be assembled with such a connector includes a sealing member for sealing between the connector and the mating connector by contacting the peripheral wall when the connector and the mating connector are assembled. By holding the sealing member and the peripheral wall in close contact with each other, sealability between the connector and the mating connector is ensured.

According to the above configuration, sealability between the connector and the mating connector is ensured by the contact of the sealing member with the peripheral wall including the projecting part when the connector and the mating connector are assembled. If the exposure opening is provided from a tip to a base end of the first wall, the sealing member has a part not to be brought into contact with the peripheral wall, wherefore it becomes difficult to ensure sealability.

### DETAILS OF EMBODIMENT OF PRESENT DISCLOSURE

### Embodiment

One embodiment of an electrical connection device provided with a connector of the present disclosure is described below with reference to the drawings. The electrical connection device of this embodiment is used in a connection part in a wiring harness for a high-voltage power supply of a vehicle. Note that the present invention is not limited to these illustrations and is intended to be represented by claims and include all changes in the scope of claims and in the meaning and scope of equivalents.

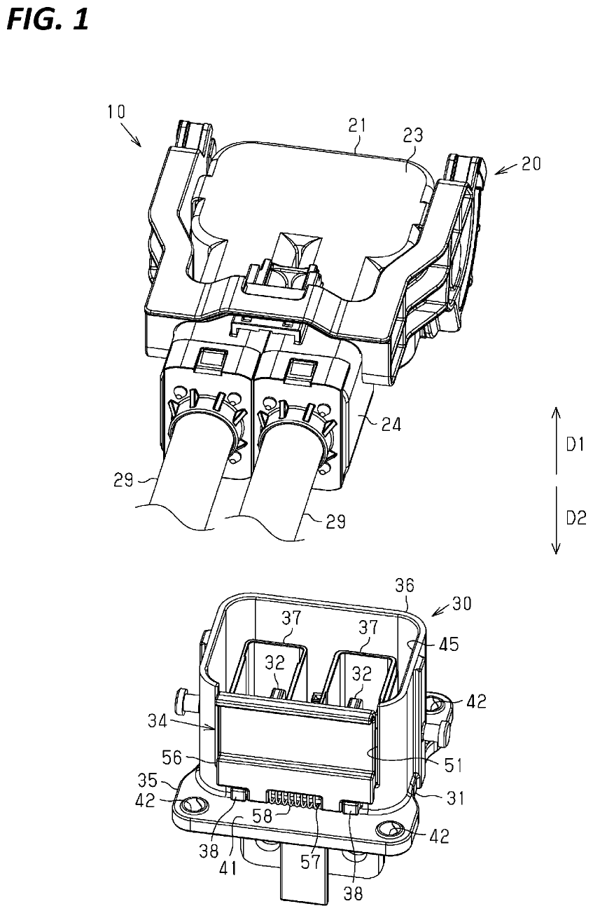

As shown in FIG. 1, an electrical connection device 10 includes a first connector 20 and a second connector 30. The first and second connectors 20, 30 are assembled with each other. The first and second connectors 20, 30 are electrically connected by being assembled with each other.

In this embodiment, a direction in which the second connector 30 relatively approaches the first connector 20 in the case of assembling the first and second connectors 20, 30 is referred to as a first direction D1. Further, a direction in which the first connector 20 relatively approaches the second connector 30 in the case of assembling the first and second connectors 20, 30 is referred to as a second direction D2. That is, the first and second directions D1, D2 are mutually opposite directions.

(First Connector 20)

First, the first connector 20 is described.

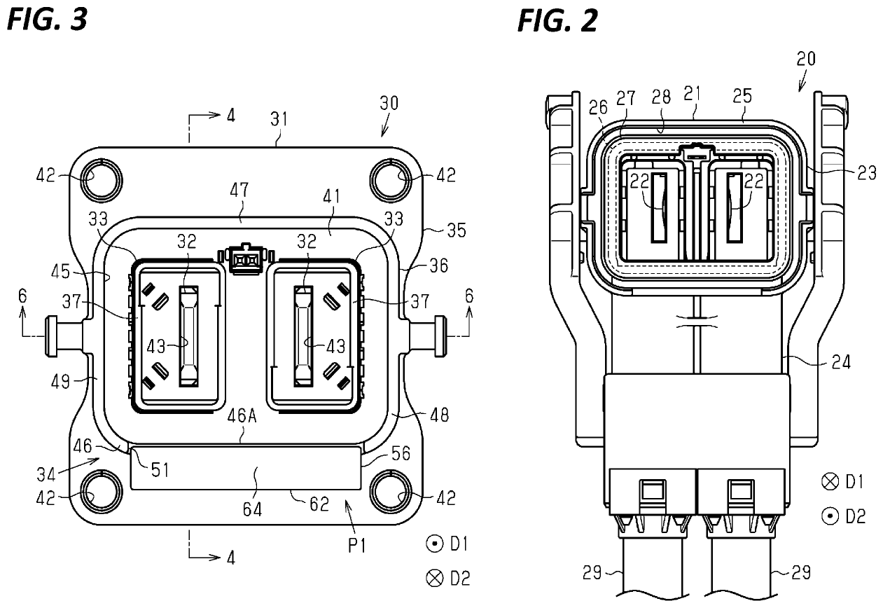

As shown in FIG. 2, the first connector 20 includes a first housing 21 and first terminals 22. The first connector 20 is a mating connector of the second connector 30.

The first housing 21 is a housing provided in the first connector 20. The first housing 21 holds the first terminals 22.

The first housing 21 includes a first accommodating portion 23 and a second accommodating portion 24. The first and second accommodating portions 23, 24 accommodate the first terminals 22. Thus, the inside of the first accommodating portion 23 and that of the second accommodating portion 24 communicate.

The first accommodating portion 23 includes an outer peripheral wall 25, an inner peripheral wall 26 and a sealing member 27.

The outer peripheral wall 25 is provided to have a rectangular shape when the first housing 21 is viewed from the first direction D1. Thus, the first accommodating portion 23 includes an accommodation opening 28 formed by the outer peripheral wall 25. The accommodation opening 28 is an opening formed in the first housing 21. The accommodation opening 28 is facing in the second direction D2 in the first housing 21. The first accommodating portion 23 of this embodiment accommodates a part of the second connector 30 through the accommodation opening 28 when the first and second connectors 20, 30 are assembled.

The inner peripheral wall 26 is provided in a region surrounded by the outer peripheral wall 25. Thus, the inner peripheral wall 26 is provided to have a rectangular shape one size smaller than the shape of the outer peripheral wall 25 when the first housing 21 is viewed from the first direction D1.

The sealing member 27 is provided on the tip of the inner peripheral wall 26. Thus, the sealing member 27 is provided to have a rectangular shape when the first housing 21 is viewed from the first direction D1. The sealing member 27 is, for example, made of a resilient material such as rubber or elastomer. The sealing member 27 contacts the second connector 30 when the first and second connectors 20, 30 are assembled. The sealing member 27 seals between the first and second connectors 20, 30 by contacting the second connector 30. In this way, sealability between the first and second connectors 20, 30 is ensured.

The second accommodating portion 24 accommodates parts of wires 29 connected to the first terminals 22. The second accommodating portion 24 is provided to extend from the outer peripheral wall 25. Specifically, the second accommodating portion 24 extends in a direction different from the first and second directions D1, D2 from one surface of the outer peripheral wall 25. Thus, a connecting direction of the first connector 20 to the second connector 30 and an extending direction of the wires 29 from the first connector 20 are different in the first connector 20. That is, the first connector 20 is an L-shaped connector bent between an input side and an output side.

The first terminal 22 is a terminal provided in the first connector 20. Two first terminals 22 are provided. The two first terminals 22 are respectively connected to two wires 29 in the first housing 21. By assembling the first and second connectors 20, 30, the first terminals 22 are electrically connected to the second connector 30.

(Second Connector 30)

Next, the second connector 30 is described.

As shown in FIG. 3, the second connector 30 includes a second housing 31, second terminals 32, shield members 33 and a protecting mechanism 34. The second connector 30 is a mating connector of the first connector 20.

(Second Housing 31)

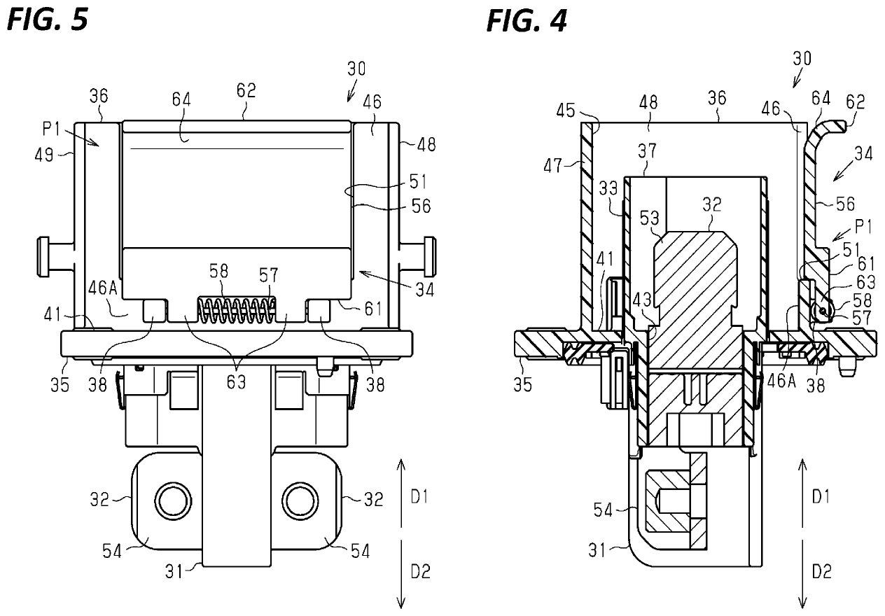

As shown in FIGS. 3 and 4, the second housing 31 is a housing provided in the second connector 30. The second housing 31 holds the second terminals 32, the shield members 33 and the protecting mechanism 34. The second housing 31 includes a fixing portion 35, a peripheral wall 36, protecting portions 37 and mounting portions 38.

The fixing portion 35 is, for example, plate-like. The fixing portion 35 of this embodiment is provided to have a rectangular shape when the second housing 31 is viewed from the second direction D2. The fixing portion 35 has a facing surface 41, fixing holes 42 and insertion holes 43.

The facing surface 41 is a surface facing the first connector 20 when the second connector 30 is assembled with the first connector 20. Thus, the facing surface 41 is a surface facing the first connector 20 in the fixing portion 35. The facing surface 41 is facing the first connector 20 in the fixing portion 35. That is, the facing surface 41 is facing in the first direction D1 in the fixing portion 35.

One or more fixing holes 42 are provided. In this embodiment, four fixing holes 42 are provided. The four fixing holes 42 are located on four corners of the fixing portion 35 when the second housing 31 is viewed from the second direction D2. The fixing holes 42 are, for example, holes into which bolts, screws or the like are inserted. By inserting bolts, screws or the like into the fixing holes 42, the fixing portion 35 is fixed to another member. As a result, the second housing 31 is mounted on another member.

The insertion hole 43 is a hole for insertion of the second terminal 32. Two insertion holes 43 are, for example, provided. The insertion holes 43 penetrate through the fixing portion 35. The insertion holes 43 of this embodiment are in the form of slits open in the facing surface 41.

The peripheral wall 36 is provided to extend in the first direction D1 from the fixing portion 35. Specifically, the peripheral wall 36 projects in the first direction D1 from the facing surface 41. The peripheral wall 36 is provided to surround the insertion holes 43 in the facing surface 41 when the second housing 31 is viewed from the second direction D2. In particular, the peripheral wall 36 is provided to surround the second terminals 32 when the second housing 31 is viewed from the second direction D2. The peripheral wall 36 is inserted between the outer peripheral wall 25 and the sealing member 27 when the first and second connectors 20, 30 are assembled. At this time, the peripheral wall 36 is held in close contact with the sealing member 27.

The peripheral wall 36 of this embodiment is provided to have a rectangular shape when the second housing 31 is viewed from the second direction D2. Thus, the second housing 31 includes a connection opening 45 formed by the peripheral wall 36. The connection opening 45 is an opening formed in the second housing 31. The connection opening 45 is facing in the first direction D1 in the second housing 31. That is, in the second housing 31, a direction facing the connection opening 45 from the facing surface 41 is the first direction D1 and a direction facing the facing surface 41 from the connection opening 45 is the second direction D2. The second connector 30 is connected to the first connector 20 through the connection opening 45.

The peripheral wall 36 includes a first wall 46, a second wall 47, a third wall 48 and a fourth wall 49. The first, second, third and fourth walls 46, 47, 48 and 49 are provided to surround the second terminals 32 on four sides when the second housing 31 is viewed from the second direction D2.

The first and second walls 46, 47 are facing each other. The third and fourth walls 48, 49 are facing each other. The first wall 46 is connected to the third and fourth walls 48, 49. The second wall 47 is connected to the third and fourth walls 48, 49. The third wall 48 is connected to the first and second walls 46, 47. The fourth wall 49 is connected to the first and second walls 46, 47.

As shown in FIGS. 3, 4 and 5, the first wall 46 is provided with an exposure opening 51. That is, the exposure opening 51 is provided in the peripheral wall 36. The exposure opening 51 is an opening for exposing the inside of the second housing 31. The exposure opening 51 of this embodiment is provided to have a rectangular shape when the first wall 46 is viewed from front.

The exposure opening 51 communicates with the connection opening 45. The exposure opening 51 is provided to avoid the interference of the first and second housings 21, 31 in the case of assembling the first and second connectors 20, 30. That is, the first housing 21 is fit into the exposure opening 51 in the case of assembling the first and second connectors 20, 30. The exposure opening 51 is necessary since the first connector 20 is an L-shaped connector.

The exposure opening 51 is provided at a position of the first wall 46 separated in the first direction D1 from the facing surface 41. That is, the exposure opening 51 is provided not from the tip to the base end of the first wall 46, but from the tip of the first wall 46 to a position between the tip and the base end. Thus, the first wall 46 includes a projecting part 46A projecting in the first direction D1 from the facing surface 41. The exposure opening 51 is so provided in the first wall 46 that the tip of the projecting part 46A serves an edge.

The projecting part 46A contacts the sealing member 27 when the first and second connectors 20, 30 are assembled. The sealing member 27 can contact the peripheral wall 36 over an entire periphery by the first wall 46 including the projecting part 46A. That is, sealability between the first and second connectors 20, 30 is ensured by the projecting part 46A. If the exposure opening 51 is provided from the tip to the base end of the first wall 46, i.e. if the first wall 46 does not include the projecting part 46A, the sealing member 27 has a part not to be brought into contact with the peripheral wall 36. In this case, it is difficult to ensure sealability.

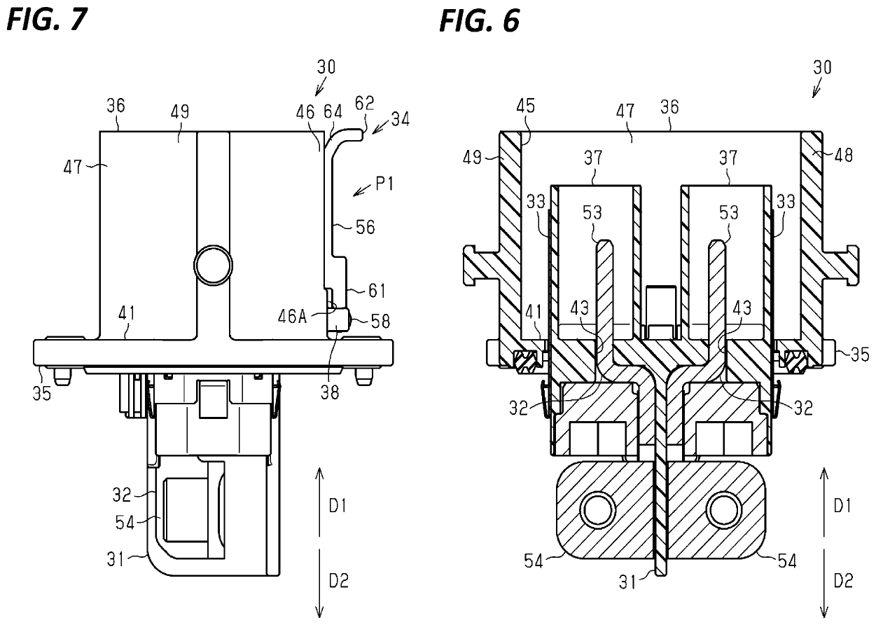

As shown in FIGS. 3 and 6, the protecting portion 37 is, for example, plate-like. The protecting portion 37 is provided to extend in the first direction D1 from the fixing portion 35. Specifically, the protecting portion 37 projects in the first direction D1 from the facing surface 41. A projection amount of the protecting portion 37 is smaller than that of the peripheral wall 36. Thus, a distance between the tip of the protecting portion 37 and the facing surface 41 is shorter than a distance between the tip of the peripheral wall 36 and the facing surface 41.

The protecting portion 37 is provided in a region surrounded by the peripheral wall 36 in the facing surface 41. The protecting portion 37 is provided to surround the second terminal 32 when the second housing 31 is viewed from the second direction D2. The protecting portion 37 protects the second terminal 32 by surrounding the second terminal 32. In this embodiment, the protecting portion 37 is provided to surround the second terminal 32 when the second housing 31 is viewed from the second direction D2. For example, the protecting portion 37 is provided to surround the second terminal 32 on four sides when the second housing 31 is viewed from the second direction D2. Thus, the protecting portion 37 of this embodiment is provided to extend around the second terminal 32 while being bent when the second housing 31 is viewed from the second direction D2. The protecting portion 37 protects the second terminal 32 by surrounding the second terminal 32. Particularly, the protecting portion 37 reduces a possibility that worker's fingers touch the second terminal 32 by protecting the second terminal 32.

In this embodiment, two protecting portions 37 are provided. The two protecting portions 37 are provided to respectively surround the two insertion holes 43. The two protecting portions 37 are provided side by side between the third and fourth walls 48, 49. In this embodiment, the two protecting portions 37 are respectively provided to have a rectangular shape when the second housing 31 is viewed from the second direction D2. In this embodiment, the two protecting portions 37 are provided symmetrically with respect to a center of the facing surface 41 when the second housing 31 is viewed from the second direction D2.

As shown in FIGS. 4 and 5, the mounting portions 38 are so configured that the protecting mechanism 34 is mounted thereon. The mounting portions 38 are, for example, mounted on the peripheral wall 36. The mounting portions 38 of this embodiment are provided on the first wall 46. More specifically, the mounting portions 38 are provided on the projecting part 46A. The mounting portions 38 hold the mounted protecting mechanism 34. In this way, the second housing 31 holds the protecting mechanism 34.

The mounting portions 38 project from the outer peripheral surface of the peripheral wall 36. That is, the mounting portions 38 are provided outside a region surrounded by the peripheral wall 36 when the second housing 31 is viewed from the second direction D2. The mounting portions 38 of this embodiment are provided to project outwardly of the peripheral wall 36 from the first wall 46 when the second housing 31 is viewed from the second direction D2. In this embodiment, two mounting portions 38 are provided. The two mounting portions 38 are provided at a predetermined distance from each other.

(Second Terminals 32)

As shown in FIGS. 3 and 6, the second terminal 32 is, for example, a busbar. The second terminal 32 is held in the second housing 31. Two second terminals 32 are provided. The two second terminals 32 are respectively inserted into the two insertion holes 43. Thus, the two second terminals 32 are respectively passed through the fixing portion 35. Each of the two second terminals 32 includes a first part 53 and a second part 54.

The first part 53 is a part to be connected to the first connector 20 in the second terminal 32. That is, the first part 53 contacts the first terminal 22 in the case of assembling the first and second connectors 20, 30.

The first part 53 is accommodated into the second housing 31. The first part 53 extends in the first direction D1 from the facing surface 41 by inserting the second terminal 32 into the insertion hole 43. Thus, the second terminal 32 can be said to project in the first direction D1 from the facing surface 41. A projection amount of the first part 53 is smaller than that of the protecting portion 37. That is, a projection amount of the second terminal 32 is smaller than that of the protecting portion 37. Thus, a distance between the tip of the second terminal 32 and the facing surface 41 is shorter than the distance between the tip of the protecting portion 37 and the facing surface 41.

The two first parts 53 are provided side by side between the third and fourth walls 48, 49. In this embodiment, the two first parts 53 are provided in parallel to the third and fourth walls 48, 49. The two first parts 53 are respectively provided to be surrounded by the two protecting portions 37.

Here, “parallel” in this specification means not only strictly parallel, but also substantially parallel within a range in which functions and effects in this embodiment are achieved.

The second part 54 is, for example, a part to be connected to an unillustrated wire in the second terminal 32. Two second parts 54 are respectively connected to unillustrated two wires. The second part 54 protrudes out from the second housing 31. The second part 54 is provided on a side opposite to the peripheral wall 36 with respect to the fixing portion 35. The second part 54 is provided to extend in the second direction D2 from the fixing portion 35.

(Shield Members 33)

The shield member 33 is made of metal. The shield member 33 is, for example, a plate-like member. The shield member 33 is held in the second housing 31. The shield member 33 is provided along the protecting portion 37. Thus, the shield member 33 of this embodiment is provided along the protecting portion 37 while being bent when the second housing 31 is viewed from the second direction D2. The shield member 33 of this embodiment is provided between the protecting portion 37 and the peripheral wall 36 and mounted on the protecting portion 37.

The shield member 33 is provided to surround the second terminal 32, similarly to the protecting portion 37. A possibility that the second terminal 32 is affected by noise is reduced by the shield member 33 surrounding the second terminal 32. Further, the strength of the protecting portion 37 is improved by the shield member 33.

The shield member 33 of this embodiment is provided to partially surround the second terminal 32 when the second housing 31 is viewed from the second direction D2. The shield member 33 is provided to surround the second terminal 32 on three sides when the second housing 31 is viewed from the second direction D2. Thus, the shield member 33 of this embodiment is provided partially along the protecting portion 37.

In this embodiment, two shield members 33 are provided. The two shield members 33 are respectively provided along the two protecting portions 37. In this embodiment, one of the two shield members 33 is provided to have a C shape and the other is provided to have an inverted C shape when the second housing 31 is viewed from the second direction D2.

(Protecting Mechanism 34)

As shown in FIGS. 5 and 7, the protecting mechanism 34 is held in the second housing 31. The protecting mechanism 34 is a mechanism for protecting the second terminals 32. The protecting mechanism 34 includes a cover 56, a shaft member 57 and a pressing member 58.

The cover 56 is a member for protecting the second terminals 32. The cover 56 is, for example, a plate-like member. The cover 56 is mounted on the mounting portions 38. In this way, the cover 56 is held on the second housing 31. The cover 56 is mounted on the mounting portions 38 via the shaft member 57. The cover 56 rotates about the shaft member 57. The cover 56 is displaced by rotating.

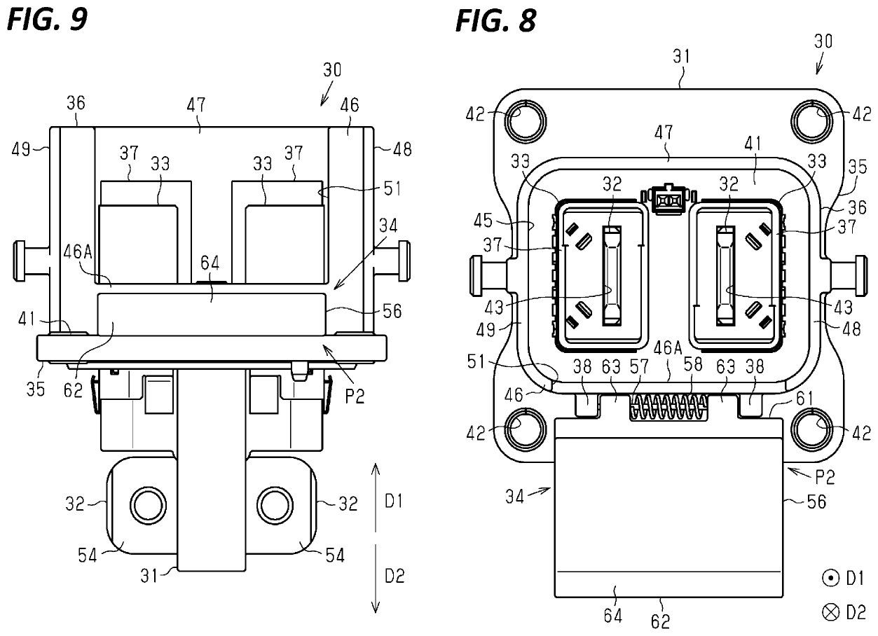

As shown in FIGS. 5, 7, 8 and 9, the cover 56 is configured to be displaced between a first position P1 where the cover 56 closes the exposure opening 51 and a second position P2 where the cover 56 is retracted from the exposure opening 51. That is, the cover 56 closes and opens the exposure opening 51. If the cover 56 is closed, the exposure opening 51 is closed. If the cover 56 is opened, the exposure opening 51 is exposed. The cover 56 shown in FIGS. 5 and 7 is located at the first position P1. The cover 56 shown in FIGS. 8 and 9 is located at the second position P2. In this way, the cover 56 is displaced between the first position P1 and the second position P2 by rotating about the shaft member 57.

The cover 56 includes a first end part 61, on which the shaft member 57 is mounted, and a second end part 62 opposite to the first end part 61. The first end part 61 is mounted on the mounting portions 38 via the shaft member 57. The cover 56 further includes holding parts 63 and an extending part 64.

The holding parts 63 are parts of the cover 56 for holding the shaft member 57. The holding members 63 are provided on the first end part 61. The holding parts 63 are so provided that the shaft member 57 is inserted therethrough. The holding parts 63 hold the shaft member 57 by having the shaft member 57 inserted therethrough. The cover 56 becomes rotatable by the holding parts 63 holding the shaft member 57. In this embodiment, two holding parts 63 are provided. The two holding parts 63 are provided at a distance from each other on the first end part 61.

The extending part 64 is provided on the second end part 62. The extending part 64 is a part extending outwardly of the peripheral wall 36 from the side of the first end part 61 toward the second end part 62 when the cover 56 is located at the first position P1. The extending part 64 of this embodiment extends from the side of the first end part 61 toward the second end part 62 while being curved.

The cover 56 is located along the first wall 46 when being located at the first position P1. The cover 56 located at the first position P1 is so located that the second end part 62 and the tip of the peripheral wall 36 are substantially flush with each other when the first wall 46 is viewed from front. In this embodiment, the second end part 62 slightly protrudes in the first direction D1 with respect to the tip of the peripheral wall 36.

The cover 56 is located along the fixing portion 35 when being located at the second position P2. The cover 56 located at the second position P2 is located between the facing surface 41 and the tip of the projecting part 46A when the first wall 46 is viewed from front. That is, if the first wall 46 is viewed from front when the cover 56 is located at the second position P2, the exposure opening 51 is entirely exposed.

The shaft member 57 is mounted on the second housing 31 and the cover 56. In particular, the shaft member 57 is mounted on the mounting portions 38 and the holding parts 63. Both ends of the shaft member 57 are held by the two mounting portions 38.

The pressing member 58 is, for example, a coil spring. In this case, the shaft member 57 is inserted through the pressing member 58. In this way, the pressing member 58 is mounted on the shaft member 57. The pressing member 58 is provided between the two holding parts 63. The pressing member 58 contacts the second housing 31 and the cover 56. The pressing member 58 contacts, for example, the fixing portion 35 and the cover 56.

The pressing member 58 presses the cover 56 such that the cover 56 is displaced to the first position P1. In particular, the pressing member 58 presses the cover 56 in a counterclockwise direction in FIG. 7 with respect to the second housing 31. Thus, the cover 56 is normally located at the first position P1. For example, the cover 56 is located at the first position P1 when the first and second connectors 20, 30 are not assembled. In contrast, when the first and second connectors 20, 30 are assembled, the cover 56 is displaced to the second position P2 by being pressed by the first connector 20. This point will be described later.

(Movements of Cover 56)

Next, movements of the cover 56 are described.

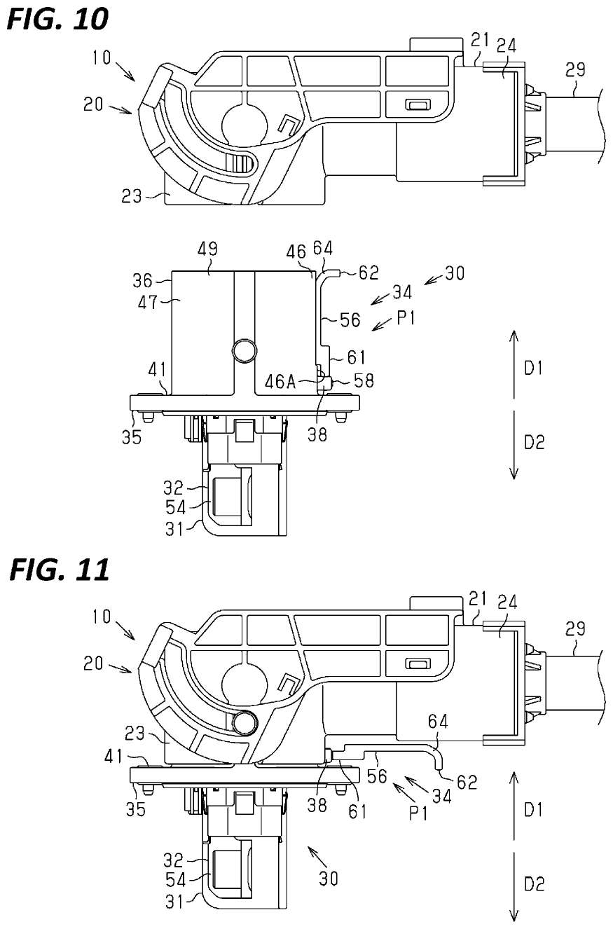

As shown in FIG. 10, the cover 56 is located at the first position P1 before the first and second connectors 20, 30 are assembled, i.e. when the first and second connectors 20, 30 are not assembled. This is because the cover 56 is pressed by the pressing member 58 to be displaced to the first position P1 as described above.

If the first connector 20 approaches the second connector 30, the first housing 21 contacts the cover 56. Specifically, the first connector 20 moves in the second direction D2 with respect to the second connector 30, whereby the outer peripheral wall 25 contacts the extending part 64.

If the first connector 20 further moves in the second direction D2, the cover 56 is so displaced that the extending part 64 is pushed away by the first housing 21. At this time, as the first housing 21 moves in the second direction D2, the extending part 64 is displaced in contact with the first and second accommodating portions 23, 24. In this embodiment, the extending part 64 moves along the first and second accommodating portions 23, 24 as the first housing 21 moves in the second direction D2. In this way, the cover 56 rotates about the shaft member 57. That is, as the first housing 21 moves in the second direction D2, the cover 56 is displaced from the first position P1 toward the second position P2.

As shown in FIG. 11, if the first and second connectors 20, 30 are assembled, the cover 56 is displaced to the second position P2. If the cover 56 is displaced to the second position P2, the exposure opening 51 is exposed. If the first and second connectors 20, 30 are assembled, the first housing 21 is fit into the exposure opening 51. That is, when the first and second connectors 20, 30 are assembled, the cover 56 is retracted from the exposure opening 51, thereby not hindering the assembling of the first and second connectors 20, 30. If the first and second connectors 20, 30 are disassembled, the cover 56 is displaced toward the first position P1 by the pressing member 58.

Next, functions and effects of this embodiment are described.

(1) The cover 56 is provided to be displaced between the first position P1 where the cover 56 closes the exposure opening 51 and the second position P2 where the cover 56 is retracted from the exposure opening 51.

According to the above configuration, when the first and second connectors 20, 30 are assembled, the cover 56 is located at the second position P2, thereby reducing a possibility of interference of the first connector 20 with the second connector 30. On the other hand, when the first and second connectors 20, 30 are not assembled, the cover 56 is located at the first position P1, thereby closing the exposure opening 51. By the cover 56 closing the exposure opening 51, a possibility that worker's fingers touch the second terminals 32 is reduced.

(2) The pressing member 58 presses the cover 56 such that the cover 56 is displaced to the first position P1. The cover 56 is provided to be displaced to the second position P2 by being pressed by the first connector 20 when the first and second connectors 20, 30 are assembled.

According to the above configuration, the cover 56 is displaced to the second position P2 as the first and second connectors 20, 30 are assembled. The cover 56 is displaced to the first position P1 as the first and second connectors 20, 30 are disassembled. In this way, a possibility that the cover 56 is inadvertently displaced to the second position P2 is reduced. That is, since it becomes difficult to access the inside of the second housing 31 through the exposure opening 51, a possibility that worker's fingers touch the second terminals 32 is reduced.

(3) The cover 56 is displaced between the first position P1 and the second position P2 by rotating about the shaft member 57.

According to the above configuration, the cover 56 configured to be displaced between the first position P1 and the second position P2 can be relatively easily configured.

(4) The extending part 64 extends outwardly of the peripheral wall 36 from the side of the first end part 61 toward the second end part 62 when the cover 56 is located at the first position P1.

According to the above configuration, when the first and second connectors 20, 30 are assembled, the first connector 20 contacts the extending part 64, whereby the cover 56 is easily displaced to the second position P2.

(5) The pressing portions 37 are provided to surround the second terminals 32 in the region surrounded by the peripheral wall 36 when the second housing 31 is viewed from the second direction D2.

According to the above configuration, a possibility that worker's fingers touch the second terminals 32 is reduced by the pressing portions 37 surrounding the second terminals 32.

(6) The exposure opening 51 is so provided in the first wall 46 that the tip of the projecting part 46A serves as an edge.

According to the above configuration, the sealing member 27 contacts the peripheral wall 36 including the projecting part 46A when the first and second connectors 20, 30 are assembled, whereby sealability between the first and second connectors 20, 30 is ensured. If the exposure opening 51 is provided from the tip to the base end of the first wall 46, the sealing member 27 has a part not to be brought into contact with the peripheral wall 36. Thus, it is difficult to ensure sealability.

(7) When the first and second connectors 20, 30 are not assembled, the cover 56 closes the exposure opening 51, whereby the strength of the peripheral wall 36 is improved.

(Modifications)

The above embodiment can be modified and carried out as follows. The above embodiment and the following modifications can be carried out in combination without technically contradicting each other.
The cover 56 may be displaced between the first position P1 and the second position P2, for example, by sliding without being limited to being displaced between the first position P1 and the second position P2 by rotating.
The pressing member 58 may be, for example, a leaf spring without being limited to a coil spring.
The extending part 64 may obliquely extend without being limited to extending in a curved manner.
The outer peripheral wall 25 may be provided with a curved surface or inclined surface instead of providing the cover 56 with the extending part 64. That is, the outer peripheral wall 25 may have a shape such as a curved surface or inclined surface to push away the second end part 62 of the cover 56 when the first and second connectors 20, 30 are assembled.
Instead of including the extending part 64, the cover 56 may be provided at an acute angle with respect to the first wall 46 when being located at the first position P1. Even in this case, the cover 56 is displaced toward the second position P2 by being pressed by the first connector 20 when the first and second connectors 20, 30 are assembled.
The cover 56 may be displaced between the first position P1 and the second position P2, for example, by the operation of a worker without depending on the assembling of the first and second connectors 20, 30.
As shown in FIG. 2, the sealing member 27 may protrude toward an outer peripheral side of the inner peripheral wall 26 over the entire periphery of the inner peripheral wall 26 and cover a part of the outer surface of the inner peripheral wall 26. In this way, the peripheral wall 36 may be inserted between the outer peripheral wall 25 and the inner peripheral wall 26 and held in close contact with the sealing member 27 with the first and second connectors 20, 30 assembled.
A part between the first end part 61 and the extending part 64 in the cover 56 shown in FIGS. 4 and 5 may be referred to as a main part. The main part may be substantially parallel to the first wall 46. The extending part 64 may be curved or inclined outwardly of the peripheral wall 36 along the first direction D1 from the main part. The extending part 64 may slightly protrude in the first direction D1 with respect to the tip of the peripheral wall 36. As shown in FIG. 10, a position where the outer peripheral wall 25 is fittable to the outer periphery of the peripheral wall 36 by a linear movement of the first connector 20 along the second direction D2 is referred to as an assemblable position. The extending part 64 may extend further outward than the outer peripheral wall 25 at the assemblable position.
The facing surface 41 may be referred to as a base surface of the second housing 31. The peripheral wall 36 of the embodiment may be referred to as a receptacle of the second housing 31. The first direction D1 of this embodiment may be referred to as a height direction of the peripheral wall 36. The exposure opening 51 of the peripheral wall 36 of the embodiment may be referred to as a cutout-like lateral window of the peripheral wall 36. The cover 56 of this embodiment may be referred to as a flap or hinge flap. The cover 56 and the pressing member 58 of the embodiment may be referred to as a self-closing flap configured to automatically close the exposure opening 51 of the peripheral wall 36 without any supply of power.
As shown by cross-section hatching in FIGS. 4 and 6, the second housing 31 may be made of resin, possibly insulating resin, and the second terminals 32 may be metal. The second housing 31 may be configured as a one-piece article as in a shown example.

As shown in FIGS. 1, 4 and 5, the cover 56 may, for example, completely close the exposure opening 51 of the peripheral wall 36 with the second connector 30 and the first connector 20 separated. Accordingly, the cover 56 is advantageous in suppressing the touch of worker's fingers approaching the second connector 30 from above the peripheral wall 36 with the second terminals 32 and is also advantageous in suppressing the touch of worker's fingers approaching the second connector 30 from a lateral side of the peripheral wall 36 with the second terminals 32 through the exposure opening 51 of the peripheral wall 36 when the worker connects the second and first connectors 30, 20.

The present disclosure includes the following implementation examples. Reference signs of several constituent elements of the illustrative embodiment are given not for limitation, but for understanding assistance. Some of features described in the following implementation examples may be omitted or several of the features described in the implementation examples may be selected or extracted and combined.

[Addendum 1] A connector (30) including:

a housing (31) having a base surface (41);

a terminal (32) held in the housing (31) and projecting in a first direction (D1) from the base surface (41); and

a cover (56) to be held on the housing (31),

wherein:

the housing (31) includes a peripheral wall (36) projecting in the first direction (D1) from the base surface (41) and provided to surround the terminal (32) when viewed from a second direction (D2) opposite to the first direction (D1),

the peripheral wall (36) is provided with an exposure opening (51) for exposing the inside of the housing (31), and

the cover (56) is provided to be displaced between a first position (P1) where the cover (56) closes the exposure opening (51) and a second position (P2) where the cover (56) is retracted from the exposure opening (51).

[Addendum 2] The connector (30) according to one aspect of the present disclosure may include a pressing member (58) for pressing the cover (56) such that the cover (56) is displaced to the first position (P1).

[Addendum 3] The connector (30) according to one aspect of the present disclosure may include a shaft member (57) to be mounted on the housing (31) and the cover (56),

the pressing member (58) may be mounted on the shaft member (57),

the cover (56) may be displaced between the first position (P1) and the second position (P2) by rotating about the shaft member (57),

the cover (56) may include a first end part (61) on which the shaft member (57) is mounted, a second end part (62) opposite to the first end part (61), a main part and an extending part (64),

the extending part (64) may be provided between the main part and the second end part (62), and

the extending part (64) may extend outwardly of the peripheral wall (36) while being curved or inclined from the main part toward the second end part (62) when the cover (56) is located at the first position (P1).

[Addendum 4] In the connector (30) according to one aspect of the present disclosure, the extending part (64) may protrude in the first direction (D1) with respect to the tip of the peripheral wall (36).

[Addendum 5] An electrical connection device (10) including a first connector (20) and a second connector (30), wherein:

the first connector (20) includes a first housing (21) having an accommodating portion (23),

the accommodating portion (23) includes:

an outer peripheral wall (25);

an inner peripheral wall (26) provided in a region surrounded by the outer peripheral wall (25); and

a sealing member (27) provided on the tip of the inner peripheral wall (26),

the sealing member (27) protrudes toward an outer peripheral side of the inner peripheral wall (26) over an entire periphery of the inner peripheral wall (26) and is provided to cover a part of an outer surface of the inner peripheral wall (26),

the second connector (30) includes:
a second housing (31) having a base surface (41) facing the first connector (20) when the second connector (30) is assembled with the first connector (20);
a terminal (32) held in the second housing (31) and projecting in the first direction (D1) from the base surface (41); and
a cover (56) to be held on the second housing (31),

the second housing (31) includes an intermediate peripheral wall (36) projecting in the first direction (D1) from the base surface (41) and provided to surround the terminal (32) when viewed from a second direction (D2) opposite to the first direction (D1),

the intermediate peripheral wall (36) is provided with an exposure opening (51) for exposing the inside of the second housing (31),

the cover (56) is provided to be displaced between a first position (P1) where the cover (56) closes the exposure opening (51) and a second position (P2) where the cover (56) is retracted from the exposure opening (51), and

the intermediate peripheral wall (36) is inserted between the outer peripheral wall (25) and the inner peripheral wall (26) and held in close contact with the sealing member (27) when the first connector (20) and the second connector (30) are assembled.

[Addendum 6] In the electrical connection device (10) according to one aspect of the present disclosure,

the second connector (30) may include:
a pressing member (58) for pressing the cover (56) such that the cover (56) is displaced to the first position (P1); and
a shaft member (57) to be mounted on the second housing (31) and the cover (56),

the pressing member (58) may be mounted on the shaft member (57),

the cover (56) may be displaced between the first position (P1) and the second position (P2) by rotating about the shaft member (57),

the cover (56) may include a first end part (61) on which the shaft member (57) is mounted, a second end part (62) opposite to the first end part (61), a main part and an extending part (64),

the extending part (64) may be provided between the main part and the second end part (62),

the extending part (64) may extend outwardly of the intermediate peripheral wall (36) while being curved or inclined from the main part toward the second end part (62) when the cover (56) is located at the first position (P1),

a position where the outer peripheral wall (25) is fit to an outer periphery of the intermediate peripheral wall (36) by a linear movement of the first connector (20) along the second direction (D2) may be referred to as an assemblable position, and

the extending part (64) may extend further outward than the outer peripheral wall (25) at the assemblable position.

[Addendum 7] In the electrical connection device (10) according to one aspect of the present disclosure, the extending part (64) may protrude in the first direction (D1) with respect to the tip of the intermediate peripheral wall (36).

### LIST OF REFERENCE NUMERALS

10 electrical connection device
20 first connector
21 first housing
22 first terminal
23 first accommodating portion
24 second accommodating portion
25 outer peripheral wall
26 inner peripheral wall
27 sealing member
28 accommodation opening
29 wire
30 second connector
31 second housing
32 second terminal
33 shield member
34 protecting mechanism
35 fixing portion
36 peripheral wall
37 protecting portion
38 mounting portion
41 facing surface
42 fixing hole
43 insertion hole
45 connection opening
46 first wall
46A projecting part
47 second wall
48 third wall
49 fourth wall
51 exposure opening
53 first part
54 second part
56 cover
57 shaft member
58 pressing member
61 first end part
62 second end part
63 holding part
64 extending part
D1 first direction
D2 second direction
P1 first position
P2 second position

1. A connector, comprising:
a housing having a facing surface facing a mating connector when the connector is assembled with the mating connector;
a terminal held in the housing, the terminal projecting in a first direction from the facing surface; and
a cover to be held on the housing,
wherein:
the housing includes a peripheral wall projecting in the first direction from the facing surface and provided to surround the terminal when viewed from a second direction opposite to the first direction,
the peripheral wall is provided with an exposure opening for exposing inside of the housing, and
the cover is provided to be displaced between a first position where the cover closes the exposure opening and a second position where the cover is retracted from the exposure opening.

2. The connector of claim 1, comprising a pressing member for contacting the housing and the cover, wherein:
the pressing member presses the cover such that the cover is displaced to the first position, and
the cover is provided to be displaced to the second position by being pressed by the mating connector when the connector and the mating connector are assembled.

3. The connector of claim 2, comprising a shaft member to be mounted on the housing and the cover, wherein:
the pressing member is mounted on the shaft member, and
the cover is displaced between the first position and the second position by rotating about the shaft member.

4. The connector of claim 3, wherein:
the cover includes a first end part, the shaft member being mounted on the first end part, a second end part opposite to the first end part and an extending part,
the extending part is provided on the second end part, and
the extending part extends outwardly of the peripheral wall from the side of the first end part toward the second end part when the cover is located at the first position.

5. The connector of claim 1, wherein:
the housing includes a protecting portion for protecting the terminal,
the protecting portion projects in the first direction from the facing surface, and
the protecting portion is provided to surround the terminal in a region surrounded by the peripheral wall when the housing is viewed from the second direction.

6. The connector of claim 1, wherein:
the peripheral wall includes a first wall provided with the exposure opening,
the first wall includes a projecting part projecting in the first direction from the facing surface, and
the exposure opening is so provided in the first wall that a tip of the projecting part serves as an edge.
